(19) United States
(12) Patent Application Publication
(10) Pub. No.: US 2014/0039976 A1
(43) Pub. Date: Feb. 6, 2014

(54) VIDEO INFORMATION ANALYSIS SYSTEM

(71) Applicant: JCC Corp., Tokyo (JP)

(72) Inventor: Takatoshi ISHII, Tokyo (JP)

(21) Appl. No.: 13/829,698

(22) Filed: Mar. 14, 2013

(30) Foreign Application Priority Data
Aug. 2, 2012 (JP) 2012-172034
Dec. 28, 2012 (JP) 2012-288642

(51) Int. Cl. G06Q 30/02

(52) U.S. Cl. CPC G06Q 30/0201
USPC 705/7.29

(57) ABSTRACT

A video information analysis system that objectively and instantaneously evaluates a value of broadcasting information broadcasted on television or video information distributed and provided through the Internet to make it possible to examine influences including an economic influence of the television related broadcasting information or the video information provided through the Internet on a company, an association, an individual, a commodity, a service, a brand and the like, and compares the pieces of information with various economic indicators to make it possible to consider correlation between the video information and the evaluations of the company, the association, and the like.

### TECHNICAL FIELD

The present invention relates to a video information analysis system.

### BACKGROUND ART

On TV, pieces of broadcasting information of various types are aired through broadcasting stations. However, an economic influence of specific broadcasting information on companies and associations has not been examined.

At the present, in consideration of a situation in which a great number of programs are broadcasted on TV from early morning until midnight, not only broadcasting information directly related to a specific company, an economic company of an association, or a group activity, but also broadcasting information related to an international case that is not supposed to be directly related to the company or the association, broadcasting information related to a social fact, or the like may consequently influence the economic evaluation of the specific company or the specific association.

More specifically, an influence of broadcasting information broadcasted on TV on economic evaluation of a specific company and a specific association may be directly reflected on the stock prices of the company and the association when it is broadcasted through a news program or a variety show on TV that a certain manufacturer press-releases a new product.

Degrees of such reflection change depending on broadcast time zones of the news program or the variety show that reported the above fact, or depending on whether the program is a program on a national broadcast network or a program on a local broadcast network.

Even though there is no direct economic relation, for example, in case of the nuclear accident in 2011 Tohoku earthquake and tsunami, electric power companies and related companies are supposed to be very economically and socially influenced because all Japanese television stations broadcasted accident conditions of Fukushima I Nuclear Power Plant for a long period of time. Furthermore, large fluctuations in exchange or serious disaster information in a foreign country in which a Japanese company is present is broadcasted, it can be easily supposed that the stock prices of export-oriented firms or associations are considerably influenced.

An economic influence of such television broadcasting information on related companies and associations or an economic influence on companies or associations that are apparently unrelated to the television broadcasting information have not been examined and pursued till now.

In recent years, a business that distributes and provides moving images through the Internet at no charge or at a charge has been established. The service is used by many users through personal computers, mobile phones including browsers, or mobile terminals such as smart phones. In such a so-called video delivery service, like a television, specialized videos or the like such as news images, commercial messages, variety shows, movies, and specialized videos classified by various themes can be viewed. In addition, similarly, a mobile phone or a mobile terminal such as a smart phone including a browser is used, news or the like of companies that provide search engines can also be viewed. The above videos distributed through the Internet are under the same circumstances as those in the television broadcasting.

Based on this standpoint, the present applicant made an investigation before application to search related application information to extract Patent Document 1. However, Patent Document 1 is not a conventional art related to the present invention.

[Patent Document] Publication No. 2007-264969

### DISCLOSURE OF THE INVENTION

### Problem to be Solved by the Invention

It is an object of the present invention to provide a video information analysis system that objectively and instantaneously evaluates the worth of broadcasting information broadcasted on TV or video information distributed and provided through the Internet to make it possible to examine an influence including an economic influence of TV-related broadcasting information or video information provided through the Internet on companies, associations, individuals, commodities, service, brands, and the like and compares the information with various economic indicators to make it possible to consider correlations between the video information and the evaluations of the companies, the associations, and the like.

### Means for Solving the Problem

In order to solve the above problem, an invention described in claim 1 is that a video information analysis system that analyzes video information to evaluate a predetermined target includes: a video information storage device having a “record file” in which all programs broadcasted in all TV channels or all videos distributed through the Internet are recorded or stored as video information for a predetermined period of time and a “video information database” in which all the pieces of video information stored in the “record file” and text data of summaries of all the pieces of video information are stored; and a “video information evaluation device” that extracts related information data to be evaluated from the video information data stored in the “video information database” in units of articles to evaluate the related information data, wherein the “video information evaluation device” has “evaluation target information extraction means” that searches for and extracts video information related to a target in the text data stored in the “video information database” for a predetermined period of time, and a “video information evaluation means” that calculates the evaluation value of the video information on the basis of a determination of whether the video information extracted by the “evaluation target information extraction means” has a positive evaluation obtained when a good influence is exerted on the evaluation target, a negative evaluation obtained when a bad influence is exerted on the evaluation target, or a neutral evaluation that is neither a positive evaluation nor a negative evaluation and stores the evaluation value in a “video information evaluation value database”.

An invention described in Claim 2 is characterized in that the “video information” is TV broadcasting information, and is related to a broadcast station name, an in-program section, a commercial message (CM), in units of themes, a title of a program, an airdate of a program, broadcast time on the second time scale, cueing information on the second time scale, a broadcast time length on the second time scale, video contents, sound, a telop, a performer, and a company name, an association name, a commodity name, a brand name, a service name, a specific personal name, a specific place name, and a specific building name that appear on a program.

An invention described in Claim 3, that the “video information” is moving image information distributed through the Internet, and is related to an in-moving-image section, a commercial message (CM), in units of themes, a title of a program, a release date of a moving image, a publication site, a writer, a sponsor, a performer, a director, video time on the second time scale, a video time length on the second time scale, video contents, sound, a telop, a performer, and a company name, an association name, a commodity name, a brand name, a service name, a specific personal name, a specific place name, and a specific building name that appear on a moving image.

An invention described in Claim 4 is that the “video information evaluation means” has a “video information evaluation value calculation means”, a “commercial message time-unit-price database” in which a table of station-classified time-unit-price information of a commercial message in each broadcast station is stored, and a “video information evaluation value database”, and the “video information value calculation means” is configured to, with reference to a time-unit-price of the “commercial message time-unit-price database”, multiply the time-unit-price by broadcast time of the corresponding video information and add each of coefficients of the positive evaluation, the negative evaluation, and the neutral evaluation to calculate a video information evaluation value related to an evaluation target, and store the video information evaluation value in the “video information evaluation value database”.

An invention described in Claim 5 is that the “video information evaluation value calculation means” calculates the video information evaluation value in consideration of a level of importance of an evaluation target in an article related to an evaluation target extracted by the “evaluation target information extraction means”.

An invention described in Claim 6 is that a level of importance of an evaluation target in the article is determined depending on whether the evaluation target in the article is handled as a main issue, a sub-issue, or an issue except for the main issue and the sub-issue, and the level of importance is converted into a coefficient and used in calculation of a video information evaluation value.

An invention described in Claim 7 is that the video information evaluation values are calculated with respect to a positive evaluation, a negative evaluation, and a neutral evaluation, respectively.

An invention described in Claim 8 including a “video information evaluation value database” in which video information evaluation values of a plurality of evaluation targets are stored in units of the evaluation targets, and “video information evaluation value comparison means” that totals the video information evaluation values stored in the “video information evaluation value database” in units of predetermined periods, compares the stored evaluation targets with each other, and performs ranking about the plurality of evaluation targets in units of predetermined periods.

An invention described in Claim 9 is that the “video information evaluation device” includes an “economic indicator database” having an economic indicator table in which information related to an economic indicator for a predetermined period is described, and “cross-chart forming means” that searches for and extracts evaluation values of specific evaluation targets from the “video information evaluation value database”, extracts evaluation values of the specific targets based on an economic indicator from the “economic indicator database”, plots the evaluation values on the same coordinate axis for a predetermined period to make it possible to form a cross chart.

An invention described in Claim 10 is that the “economic indicator database” stores economic indicators related to stock prices, the Nikkei stock average, the Dow Jones Industrial Average, an average stock price of each country, the Shanghai foreign exchange market, currency exchange market prices of each country, petroleum prices, and gold market prices.

An invention described in Claim 11 including “most approximate economic indicator extraction means” that can extract an economic indicator being most approximate to a chart of positive evaluation, a chart of negative evaluation, and a chart of neutral evaluation from a plurality of economic indicators stored in the “economic indicator database” by using Spearman rank-correlation coefficients or a mathematical technique of regression analysis.

An invention described in Claim 12 is that the video information storage device has a “record file” in which all programs broadcasted on all TV channels or all videos distributed through the Internet are recorded or stored as video information for a predetermined period and a “video information database” in which all the pieces of video information stored in the “record file” and text data of a summary of all the pieces of video information are stored, the video information evaluation device further includes: a “target evaluation determination database” in which determination data obtained depending on whether broadcasting information related to the evaluation target extracted by the “evaluation target information extraction means” has a positive evaluation obtained when a good influence is exerted on the evaluation target, a negative evaluation obtained when a bad evaluation is exerted on the evaluation target, and a neutral evaluation that is neither the positive evaluation nor the negative evaluation are stored in units of evaluation targets; and a “target level-of-importance coefficient database” in which pieces of coefficient information representing levels of importance of pieces of video information related to the evaluation targets are stored, and the “evaluation target information extraction means” searches for and extracts video information of a specific evaluation target requested from a customer through a customer-side terminal and texted information from the record database and the video information database and searches for and extracts target determination evaluation, a target level-of-importance coefficient, and a video information evaluation value from the “target evaluation determination database”, a “target level-of-importance database”, and the “video information evaluation value database” to provide the target determination evaluation, the target level-of-importance coefficient, and the video information evaluation value depending on a request from the customer.

An invention described in Claim 13 is that the evaluation target is anyone of a specific company, a specific association, a specific commodity, a specific brand, a specific service, a specific individual, a specific place name, a specific building, a specific animal name, and a specific title of the work.

### Effect of the Invention

The video information analysis system according to the invention described in claim 1 is a video information analysis system that analyzes video information to evaluate a predetermined target includes: a “video information storage device” having a “record file” in which all programs broadcasted in all TV channels or all videos distributed through the Internet are recorded or stored as video information for a predetermined period of time and a “video information database” in which all the pieces of video information stored in the “record file” and text data of summaries of all the pieces of video information are stored; and a “video information evaluation device” that extracts related video information data to be evaluated from the video information data stored in the “video information database” in units of articles to evaluate the related information data, wherein the “video information evaluation device” has “evaluation target information extraction means” that searches for and extracts video information related to a target in the text data stored in the “video information database” for a predetermined period of time, and a “video information evaluation means” that calculates an evaluation value of the video information on the basis of a determination of whether the video information extracted by the “evaluation target information extraction means” has a positive evaluation obtained when a good influence is exerted on the evaluation target, a negative evaluation obtained when a bad influence is exerted on the evaluation target, or a neutral evaluation that is neither a positive evaluation nor a negative evaluation and stores the evaluation value in a “video information evaluation value database”. For this reason, values of individual pieces of video information related to companies, associations, individuals, commodities, brands, services, place names, buildings, and the like introduced in a program broadcasted on TV or a video distributed through the Internet can be objectively and instantaneously evaluated, and, on the basis of the value of the video information, an economic influence, a social influence, or a political influence of the related video information on the companies, the associations, the individuals, and the like can be examined.

In the invention described in Claim 2, the “video information” is TV broadcasting information, and is related to a broadcast station name, an in-program section, a commercial message (CM), in units of themes, a title of a program, an airdate of a program, broadcast time on the second time scale, cueing information on the second time scale, a broadcast time length on the second time scale, video contents, sound, a telop, a performer, and a company name, an association name, a commodity name, a brand name, a service name, a specific personal name, a specific place name, and a specific building name that appear on a program. For this reason, detailed complete text data related to all TV broadcast programs can be formed.

As described above, since the “video information” includes cueing information on the second time scale, the program section to be evaluated can be recognized to be aired at a specific part, the positive evaluation, the negative evaluation, or the neutral evaluation can be easily performed.

In the invention described in Claim 3, the “video information” is video information including moving image distributed through the Internet, and is related to an in-moving-image section, a commercial message (CM), in units of themes, a title of a program, a release date of a moving image, a publication site, a writer, a sponsor, a performer, a director, video time on the second time scale, a video time length, video contents, sound, a telop, a performer, and a company name, an association name, a commodity name, a brand name, a service name, a specific personal name, a specific place name, or a specific building name that appear on a moving image. For this reason, detailed complete text data can be formed with respect to all the videos distributed and provided through the Internet.

In the invention described in Claim 4, the “video information evaluation means” has a “video information evaluation value calculation means”, a “commercial message time-unit-price database” in which a table of station-classified time-unit-price information of a commercial message in each broadcast station is stored, and a “video information evaluation value database”, and the “video information value calculation means” is configured to, with reference to a time-unit-price of the “commercial message time-unit-price database”, multiply the time-unit-price by broadcast time of the corresponding video information and add each of coefficients of the positive evaluation, the negative evaluation, and the neutral evaluation to calculate a video information evaluation value related to an evaluation target, and store the video information evaluation value in the “video information evaluation value database”. For this reason, on the basis of the price of a CM being present as a social fact, in consideration of a determination of whether the broadcasting information has a positive evaluation, a negative evaluation, or a neutral evaluation for the company association, the broadcasting information can be objectively evaluated. The determination is calculated as an objective evaluation value, and the evaluation value can be compared with the numeral values of economic indicators.

As described above, since the “video information” includes cueing information on the second time scale, for example, when a program section serving as an evaluation target is started from “19:50:10” (7:50:10 p.m.), CMs broadcasted in a period from 7:00 p.m. to 7:59 p.m. are extracted, and a video information evaluation value can be calculated with reference to a charge of CM.

In the invention described in Claim 5, the “video information evaluation value calculation means” is configured to calculate the video information evaluation value in consideration of a level of importance of the evaluation target in an article related to the evaluation target extracted by the “evaluation target information extraction means”. In the invention described in Claim 6, the level of importance of the evaluation target in the article is determined depending on whether the evaluation target in the article is handled as a main issue, a sub-issue, or an issue except for the main issue and the sub-issue, and the level of importance is converted into a coefficient and used in calculation of a video information evaluation value. For this reason, in addition to the effect of the invention described in Claim 4, a more objective video information evaluation value can be calculated.

As described above, since the “video information” includes cueing information on the second time scale, depending on a part of the program in which the program section to be evaluated is aired, evaluation related to the main issue, the sub-issue, or the other issue can be easily performed.

In the invention described in Claim 7, the video information evaluation values are calculated with respect to a positive evaluation, a negative evaluation, and a neutral evaluation, respectively. For this reason, the video information evaluation values are calculated with respect to a positive evaluation, a negative evaluation, and a neutral evaluation, respectively. For this reason, the evaluation values of the evaluations are used to make it possible to examine the relationships between the evaluation values and the economic indicator.

In the invention described in Claim 8 includes “video information evaluation value comparison means” that totals the “video information evaluation value database” in which video information evaluation values of a plurality of evaluation targets are stored in units of evaluation targets and the video information evaluation values stored in the “video information evaluation value database” in units of predetermined periods, compares the stored evaluation targets with each other, and performs ranking about the plurality of evaluation targets in units of predetermined periods. For this reason, ranking of companies, associations, individuals, and the like serving as the plurality of predetermined evaluation targets in units of days, months, and years to make it possible to provide a ranking result to a customer.

In the invention described in Claim 9, the “video information evaluation device” includes an “economic indicator database” having an economic indicator table in which information related to an economic indicator for a predetermined period is described, and “cross-chart forming means” that searches for and extracts evaluation values of specific evaluation targets from the “video information evaluation value database”, extracts evaluation values of the specific targets based on an economic indicator from the “economic indicator database”, plots the evaluation values on the same coordinate axis for a predetermined period to make it possible to form a cross chart. For this reason, a line graph is formed by plotting the video information evaluation values and the evaluation values of the companies, the associations, and the like serving as the evaluation targets based on the economic indicators on the same coordinate axis, and the cross chart can be formed. For this reason, “when specific information is broadcasted or distributed, economic evaluation for the company or the association on which the specific information is reflected” can be objectively analyzed.

As a result, in addition to the effect of the invention described in Claim 1, a video information analysis system can examine an economic influence of video image on companies, associations, or the like and compares the economic influence with an economic indicator to make it possible to consider correlations between the video information and the economic evaluations of the companies, the associations, or the like can be provided.

In the invention described in Claim 10, the “economic indicator database” stores economic indicators related to stock prices, the Nikkei stock average, the Dow Jones Industrial Average, the Shanghai foreign exchange market, petroleum prices, and gold market prices. For this reason, various economic indicators and evaluation values of broadcasting information can be compared with each other.

The invention described in Claim 11 includes “most approximate economic indicator extraction means” that can extract an economic indicator being most approximate to a chart of positive evaluation, a chart of negative evaluation, and a chart of neutral evaluation from a plurality of economic indicators stored in the “economic indicator database” by using Spearman rank-correlation coefficients or a mathematical technique of regression analysis. For this reason, an economic indicator being most approximate to broadcasting information evaluation value is searched for in the plurality of economic indicators, and correlations between the economic indicators and the broadcasting information.

In the invention described in Claim 12, the video information storage device has a “record file” in which all programs broadcasted on all TV channels or all videos distributed through the Internet are recorded or stored as video information for a predetermined period and a “video information database” in which all the pieces of video information stored in the “record file” and text data of a summary of all the pieces of video information are stored, the video information evaluation device further includes: a “target evaluation determination database” in which determination data obtained depending on whether broadcasting information related to the evaluation target extracted by the “evaluation target information extraction means” has a positive evaluation obtained when a good influence is exerted on the evaluation target, a negative evaluation obtained when a bad evaluation is exerted on the evaluation target, and a neutral evaluation that is neither the positive evaluation nor the negative evaluation are stored in units of evaluation targets; and an “evaluation level-of-importance coefficient database” in which pieces of coefficient information representing levels of importance of pieces of video information related to the evaluation targets are stored in unit of target, and the “evaluation target information extraction means” that searches for and extracts video information of a specific evaluation target requested from a customer through a customer-side terminal and texted information from the record database and the video information database and searches for and extracts target determination evaluation, a target level-of-importance coefficient, and a video information evaluation value from the “target evaluation determination database”, a “target level-of-importance coefficient database”, and the “video information evaluation value database” to provide the target determination evaluation, the target level-of-importance coefficient, and the video information evaluation value depending on a request from the customer. For this reason, the customer can instantaneously obtain and confirm broadcasting information including all pieces of record information in a predetermined period related to a specific company, association, individual, or the like serving as a requested evaluation target and text data corresponding to the record information and each broadcasting information evaluation value calculated with reference to an evaluation determination, a level-of-importance coefficient, and a charge of CM corresponding to the each of the pieces of broadcasting information.

In the invention described in Claim 13, the evaluation target is anyone of a specific company, a specific association, a specific commodity, a specific brand, a specific service, a specific individual, a specific place name, a specific building, a specific animal name, and a specific title. For this reason, evaluation including economic evaluation for almost all pieces of significant information appearing on TV broadcast or a moving image distributed through the Internet.

### BRIEF DESCRIPTION OF THE DRAWINGS

FIG. 1 is a system diagram showing an embodiment of a video information analysis system according to the present invention.

FIG. 2 is a diagram showing an embodiment of the video information analysis system and showing a table in a CM charge-in-time-unit database.

FIG. 3 is a conceptual diagram showing an embodiment of the video information analysis system according to the present invention and showing process steps of the system.

FIG. 4 is a graph showing an embodiment of the video information analysis system according to the present invention and showing an example of a cross chart formed by a cross-chart forming means constituting a broadcasting information evaluation value.

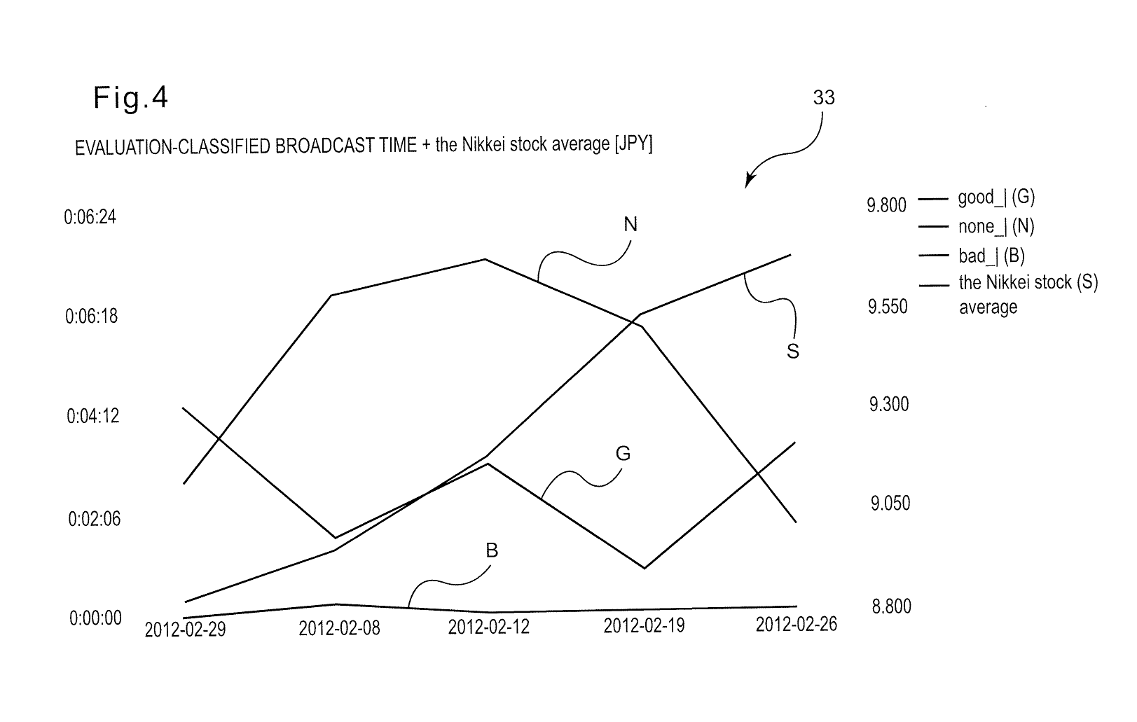

FIG. 5 is a system diagram showing another embodiment of the video information analysis system according to the present invention.

FIG. 6 is a system diagram showing another embodiment of the video information analysis system according to the present invention.

### BEST MODE FOR CARRYING OUT THE INVENTION

The present invention will be described below in detail with reference to an embodiment shown in the accompanying drawings.

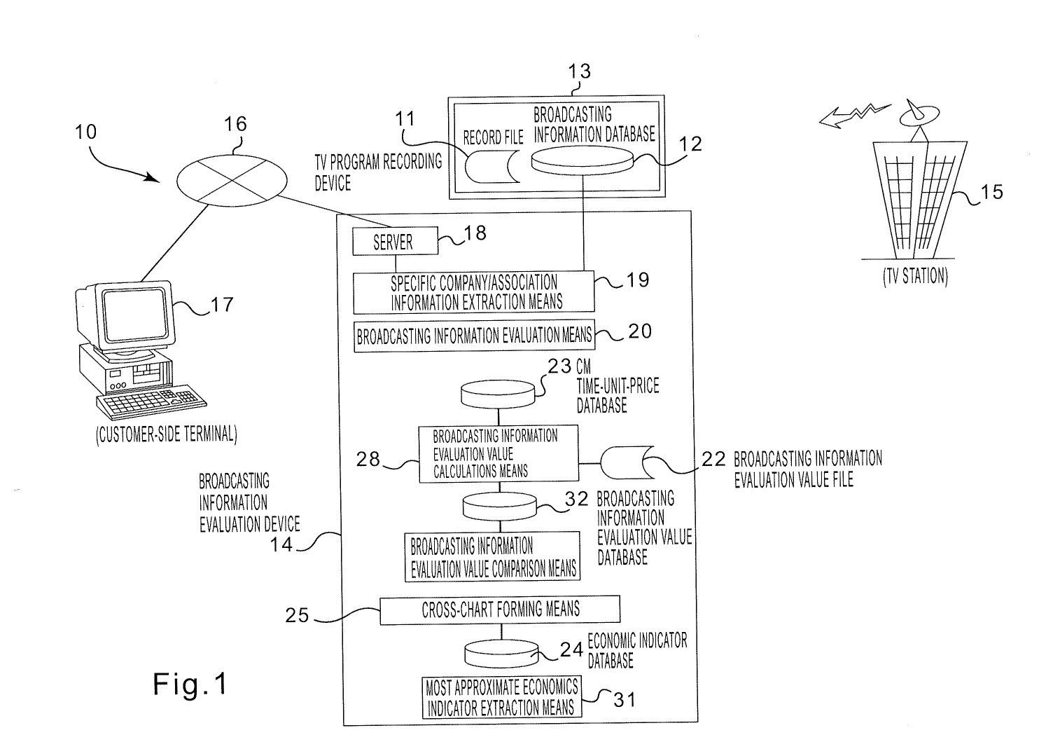

FIG. 1 shows a first embodiment of the present invention, and shows a case in which a video information analysis system according to the present invention is applied to TV information to perform economic evaluation for a specific company or a specific association.

A video information analysis system 10 according to the embodiment is configured to analyze TV broadcasting information depending on a request from a customer to perform economic evaluation for a specific company or a specific association and to make it possible to transmit a chart that can perform economic evaluation for a specific company or a specific association to a customer-side terminal through a wide-area communication network.

The video information analysis system 10 according to the embodiment includes a “TV program video information storage device” 13 having a “record file” 11 in which records all programs of each channel broadcasted by each TV station 15 are recorded for a predetermined period and stored as broadcasting information and a “broadcasting information database” 12 in which all the pieces of broadcasting information stored in the “record file” 11 are converted into text data and stored, and a “broadcasting information evaluation device” 14 that extracts related broadcasting information data of a specific company or a specific association from the broadcasting information data stored in the “broadcasting information database” 12 in units of broadcasting articles to evaluate the related broadcasting information data.

The “broadcasting article unit” mentioned here means an article between a section of a broadcast program or a commercial message (to be referred to as a “CM” hereinafter) and a CM. When an article time is long, the “broadcasting article unit” is divided in units of company names.

The “TV program video information storage device” 13 is a video recorder having a storage means that can record all TV programs for a long period and has a very large capacity. For example, the “TV program video information storage device” 13 is configured such that all broadcast programs about all TV broadcast channels, a maximum of 8 channels are recorded for a predetermined period, for example, one week or 24 weeks to make it possible to store image data in the “record file” 12.

The image data stored in the “record file” 11 are stored in the “broadcasting information database” 12 built in the “TV program video information storage device” 13 as text documents such that, regardless of the types of programs such as a news program, a variety show, a drama, and a sports program, all the programs are manually summarized with keywords with respect to an in-program section, a commercial message (CM), in units of themes, a title of a program, an airdate of a program, broadcast time on the second time scale, a broadcast time length, video contents, sound, a telop, a performer, and a company name, an association name, a commodity name, and a service name that appear on a program.

The TV program video information storage device 13 is configured such that the text document is displayed on a screen of a display device and a keyword configuring the text document is electrically selected on the screen to make it possible to reproduce a corresponding video.

The “broadcasting information evaluation device” 14 includes a server 18 that is connected to the wide-area communication network 16 and receives a request from the customer-side terminal 17, a “specific company or association information extraction means” 19 that searches for and extracts broadcasting information related to a specific company or a specific association for a predetermined period from the text data stored in the “broadcasting information database” 12 on the basis of the request from the customer-side terminal 17, and a “broadcasting information evaluation means” 20 that calculates the evaluation value of the broadcasting information on the basis of a determination of whether the broadcasting information related to the specific company or the specific association extracted by the “specific company or association extraction means” 19 has a positive evaluation obtained when a good influence is exerted on the company or the association, a negative evaluation obtained when a bad influence is exerted on the company or the association, or a neutral evaluation that is neither a positive evaluation nor a negative evaluation.

The “broadcasting information evaluation means” 20 has a “broadcasting information evaluation value calculation means” 28 and a “commercial message time-unit-price database” 23 in which a table of time-unit-price information of commercial messages is stored. The “broadcasting information evaluation value calculation means” 28 is configured to, with reference to the time-unit price of the “CM time-unit-price database” 23, multiply the time-unit price by a broadcasting length of the time of the broadcasting information, add the coefficients of the positive evaluation, the negative evaluation, and the neutral evaluation to calculate a broadcasting information evaluation value related to a specific company or a specific association to be determined, and store the broadcasting information evaluation value in the “broadcasting information evaluation value database” 32.

Furthermore, in the embodiment, the “broadcasting information evaluation device” 14 includes an “economic indicator database” 24 having an economic indicator table in which information related to economic indicators are described for a predetermined period, and a “cross-chart forming means” 25 that searches for and extracts an evaluation value of a specific company or a specific association from the “broadcasting information evaluation value database” 32, extracts an evaluation value of the specific company or the specific association based on the economic indicator from the “economic indicator database” 24, and can form a cross chart by plotting the evaluation values on the same coordinate axis for a predetermined period.

The wide-area communication network 16 corresponds to, for example, the Internet, a LAN, or the like. In the embodiment, a customer requests a corporation owning the broadcasting information evaluation device 14 to evaluate a desired company or association by the customer-side terminal 17 through the wide-area communication network 16. This request is received by the server 18 configuring the broadcasting information evaluation device 14. The request from the customer is made as a form of, for example, “require evaluation of certain corporation for a period from January to June, 2012” by specifying a period and a company name or an association name. The customer-side terminal 17 is a PDA such as a personal computer, a smart phone, or a mobile phone that accesses a wide-area communication network to make it possible to communicate information.

The “specific company or association extraction means” 19, on the basis of a request from a customer received by the server 18, sets company/association information related to a specific company or a specific association and a period requested by the customer from the broadcasting information in the “broadcasting information database” 12, performs test searching on the basis of a keyword by a company name or an association name, a keyword related to an abbreviated name of the company name or the association name, and a keyword such as a commodity or service name or an abbreviated name thereof of the company name or the association name that can specify the company and the association to perform extraction. In this manner, pieces of broadcasting information of all types broadcasted on TV within the period related to the specific company or the specific association are extracted.

When the pieces of broadcasting information of all the types broadcasted within the period related to the specific company or the specific association are extracted by the specific company/association information extraction means 19, it is determined whether the pieces of broadcasting information related to the specific company and the specific association have a positive evaluation obtained when a good influence is exerted on the specific company and the specific association, a negative evaluation obtained when a bad evaluation is exerted on the specific company and the specific association, and a neutral evaluation that is neither the positive evaluation nor the negative evaluation. On the basis of the determination, the “broadcasting information evaluation means” 20 calculates evaluation values of the pieces of broadcasting information extracted by the “specific company/association extraction means” 19.

Evaluation determination of the broadcasting information is performed as follows. For example, when news reported that a market share of a specific company in the world increased, the report has a “positive evaluation” that improve the evaluation of the company by a viewer or a consumer. On the other hand, when news reported “financial crisis in the European market”, for an export company that regards the European market as a main export market, the news has a “negative evaluation” that may give the impression that business performance of the company should be degraded. An extreme example of this case above negative evaluation is an influence of reports of the nuclear accident in 2011 Tohoku earthquake and tsunami, and may become a considerably “negative evaluation” for the electricity supply company.

Furthermore, in, for example, not only a news program, but also a popular variety show or the like, when it was broadcasted that a popular news caster, an actor, or the like introduced a brand-new car of an automobile company to appeal the brand-new car, the news may have a considerably “positive evaluation” for the automobile company to viewers.

When a CM that introduces a brand-new commodity obtained by a novel method was broadcasted and popularly talked between viewers, a company that makes the CM has a considerably “positive evaluation”. Although the company name or the association name appears in some broadcasting information, the broadcasting information may give neither a “positive evaluation” nor a “negative evaluation” to viewers. In this case, a “neutral evaluation” is determined.

Each of the determination results is used as a coefficient obtained when a broadcasting information evaluation value is calculated. More specifically, in the embodiment, the “positive evaluation”, the “negative evaluation”, and the “neutral evaluation” are given as “+1”, “−1”, and “no coefficient”, respectively.

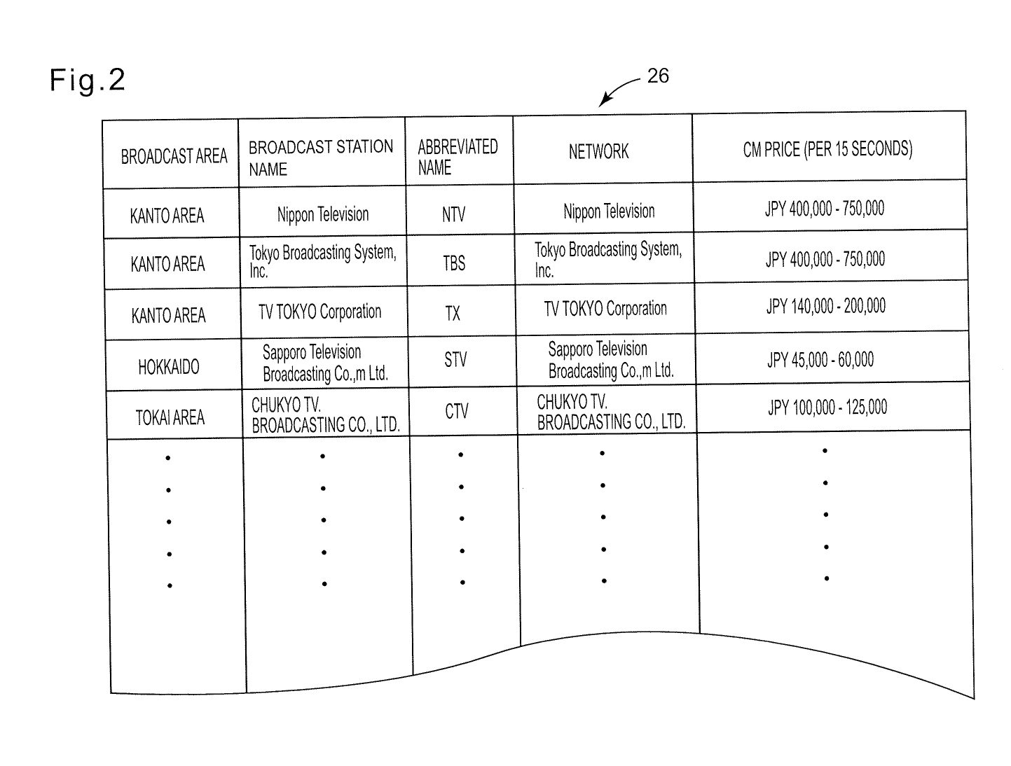

The broadcasting information evaluation value is calculated by the following “broadcasting information evaluation value calculation means” 28. More specifically, the “broadcasting information evaluation means” 20, as described above, includes a “CM time-unit-price database” 23 in which a CM time-unit-price information table 26 (see FIG. 2) is stored, a broadcasting information evaluation value calculation means 28 that, in calculation of a price of a CM of a program to which the broadcasting information belongs, with reference to a time-unit-price of the “CM time-unit-price database” 23, converts the broadcasting information into a valuation based on the CM price by multiplying the time-unit price by a broadcast time of the broadcasting time, and a broadcasting information evaluation value database 32 in which the calculated broadcasting information evaluation value is stored.

As shown in FIG. 2, in the CM time-unit-price information table 26, for example, data of a broadcast station name, a region, an abbreviation of a broadcast station name, a broadcast area, a network, and data of a time-unit price of 15-second CM is stored. Thus, the “broadcasting information evaluation value calculation means” 28 calculates a CM unit price of the program to which the broadcasting information belongs on the second time scale with reference to the CM time-unit-price information table 26, multiplies the CM unit price by a broadcast time in the program of the broadcasting article, and adds a coefficient based on the determination result to perform conversion into the CM price of the broadcasting information, thereby calculating a base value of the broadcasting information evaluation value.

The “broadcasting information evaluation value calculation means” 28 calculates a broadcasting information evaluation value on the basis of the base value in consideration of a level of importance of the specific company or the specific association in the broadcasting article related to the specific company or the specific association. More specifically, the level of importance of the company or the association in the broadcasting article is determined depending on whether the specific company or the specific association in the broadcasting article is handled as a main issue, a sub-issue, or an issue except for the main issue and the sub-issue, and the level of importance is converted into a coefficient and used in calculation of broadcasting information evaluation value.

In the embodiment, when the coefficient is set to “1” in case of the “main issue”, set to “0.5” in case of the “sub-issue”, and set to “0.1” in case of the “issue except for the main issue and the sub-issue”. Thus, depending on a level of importance of the broadcasting information, a base value of the broadcasting information evaluation value is multiplied by the coefficient to calculate a final broadcasting information evaluation value.

The calculated broadcasting information evaluation value is stored the broadcasting information evaluation value database 32. Broadcasting stations include so-called flagship stations (five main broadcasting stations in Tokyo) and so-called local stations of respective regions that broadcast report programs and amusement programs produced by the flagship stations and sold by the flagship stations through networks of the flagship stations.

In this case, since a degree of influence of a certain broadcast program on all the people of Japan changes depending on networks through which the broadcast program is broadcasted and the number of local stations by which the broadcast program is broadcasted, a broadcasting information evaluation value also changes depending on the number of local stations by which the program is broadcasted as a matter of course. Thus, in consideration of the number of local stations that broadcast the program, a further detailed broadcasting information evaluation value can be calculated.

In the embodiment, the broadcasting information evaluation device 14 includes a “broadcasting information evaluation value comparison means” 29 totals the broadcasting information evaluation values stored in the broadcasting information evaluation value database 32 in units of fiscal months and compares the broadcasting station evaluation values in units of the stored companies and associations to periodically perform ranking of the plurality of companies and associations.

In the “broadcasting information evaluation value database” 32, broadcasting information evaluation values that are always periodically calculated every day by the broadcasting information evaluation value calculation means 28 on the basis of the above method with respect to main domestic companies, for example, 4000 companies are stored. The broadcasting information evaluation value comparison means 29 searches all the broadcasting information evaluation values of the 4000 companies, for example, every day, every month, or every year and selects top 10 companies, top 20 companies, or top 50 companies of the broadcasting information evaluation values to form ranking information.

The ranking information can also be transmitted to the customer-side terminal 17 by the wide-area communication network 16 through the server 18. In addition, the information can also be widely publicly provided on a predetermined website established on the wide-area communication network.

The broadcasting information evaluation device 14 according to the embodiment includes an “economic indicator database” 24 having an economic indicator table in which information related to economic indicators are described for a predetermined period, and the “cross-chart forming means” 25 that searches for and extracts an evaluation value of a company or an association specified on the basis of a request from the customer from the “broadcasting information evaluation value database” 32, and plots the evaluation values for a predetermined period on the same coordinate axis to make it possible to form a cross chart.

In the embodiment, the “economic indicator database” 24 stores economic indicators related to stock prices, the Nikkei stock average, the Dow Jones Industrial Average, the Shanghai foreign exchange market, petroleum prices, and gold market prices.

The broadcasting information evaluation device 14 according to the embodiment further includes a “most approximate economic indicator extraction means” 31 that can extract an economic indicator being most approximate to a chart of positive evaluation, a chart of negative evaluation, and a chart of neutral evaluation from a plurality of economic indicators stored in the “economic indicator database” 24 by using Spearman rank-correlation coefficients or a mathematical technique of regression analysis.

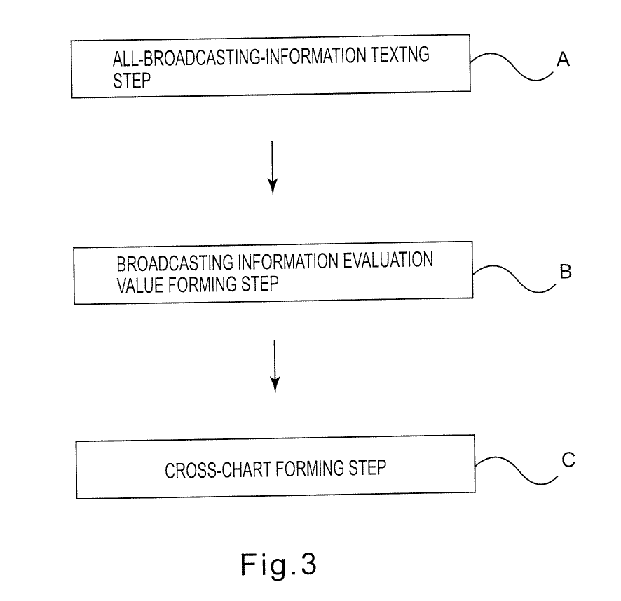

As shown in FIG. 3, the functions of the video information analysis system 10 according to the embodiment will be described in units of steps.

### 1. All Broadcasting Information Texting Step (A)

In the video information analysis system 10 according to the embodiment, all broadcast programs of each of the TV stations are recorded in the TV program video information storage device 13 for a predetermined period (for example, one week), and record data is recorded in the built-in record file 11.

The record data recorded in the record file 11 for a predetermined period are read and manually summarized with respect to an in-program section, a commercial message (CM), in units of themes, a title of a program, an airdate of a program, broadcast time on the second time scale, a broadcast time length, video contents, sound, a telop, a performer, and a company name, an association name, a commodity name, and a service name that appear on a program, and are stored as text data in the broadcasting information database 12 built in the TV program video information storage device 13.

Since an operation of text-dating all the broadcast programs broadcasted within a predetermined period is continuously performed, the text data is always accumulated in the broadcasting information database 12. For example, enormous quantity of data related to all the pieces of broadcasting information of all programs broadcasted by main 6 stations are always accumulated.

### 2. Broadcasting Information Evaluation Value Forming Step (B)

The broadcasting information evaluation device 14 receives a “specific company evaluation request” emitted from the customer-side terminal 17 of the customer through the wide-area communication network 16 and the server 18. The request from the customer is made in the form of, for example, “want to know a relationship between evaluation in broadcasting information of certain company in a period from x month x day to x month x day and an economic index”.

On the basis of the request from the customer, the broadcasting information evaluation device 14 accesses the broadcasting information database 12 built in the TV program video information storage device 13 by the specific company/association extraction means 19 and searches for and acquires all broadcasting information data related to a company or an association to be evaluated by a specific company name or a specific association name according to the request from the customer.

The broadcasting information evaluation means 20 calculates a broadcasting information evaluation value of each piece of broadcasting information related to the specific company. The calculation of the broadcasting information evaluation value is performed on the basis of a “broadcasting information evaluation value” calculated by conversion from the broadcasting information into a CM price in units of broadcasting articles. The broadcasting information evaluation value calculation means 28 calculates a CM price on the second time scale with reference to the CM price table 26 of the CM time-unit-price database 23, and multiplies the CM price by a broadcast time of the broadcasting article to calculate a base value of the broadcasting information evaluation value.

In the calculation of the broadcasting information evaluation value, as described above, the specific company extraction means 19 manually determines “positive evaluation”, “negative evaluation”, and “neutral evaluation” by the above method with respect to the specific company or the specific association acquired as described above to set a coefficient (determination coefficient) when a broadcasting information evaluation value is calculated.

In the embodiment, the “positive evaluation”, the negative evaluation, and the neutral evaluation are set as “+1”, “−1”, and “no coefficient”, respectively.

In addition to the “positive evaluation”, the “negative evaluation”, and the “neutral evaluation”, a “level of importance of a specific company or a specific association in the broadcasting article” are considered. More specifically, a level of importance of the company or the association in the broadcasting article is determined depending on whether the specific company or the specific association in the broadcasting article is handled as a main issue, handled as a sub-issue, or handled as an issue except for the main issue and the sub-issue to set a coefficient (level-of-importance coefficient).

In the embodiment, as described above, a coefficient of “1” is set in case of the main issue”, a coefficient of “0.5” is set in case of the “sub-issue”, and a coefficient of “0.1” is set in case of an “issue except for the main issue and the sub-issue”.

Thus, in the embodiment, the “broadcasting information evaluation value calculation means” 28, with reference to a time-unit price of the “commercial message time-unit-time database” 23, multiplies the time-unit price by a broadcast time of the broadcasting information, adds the coefficients of the positive evaluation, the negative evaluation, and the neutral evaluation to calculate a base value of the broadcasting information, and multiply the base value by the level-of-importance coefficient to calculate a final broadcasting information evaluation value related to a specific company or a specific association to be determined.

### 3. Cross-Chart Forming Step (C)

The cross-chart forming means 25 searches for and extracts an evaluation value of a company or an association specified on the basis of a request from the customer in the “broadcasting information evaluation database” 32 for a period designated by the request from the customer, selects any one of the economic indicators (stock prices, the Nikkei stock average, the Dow Jones Industrial Average, the Shanghai foreign exchange market, petroleum prices, or gold market prices) from the “economic indicator database” 24, extracts the evaluation value (for example, stock price) of the specific company or the specific association based on the economic indicator, and plots the evaluation values for a predetermined period on the same coordinate axis to form a cross chart.

For example, FIG. 3 shows an example of the cross chart. The cross chart 33 is a cross chart showing a relationship between broadcasting information evaluation values of a certain company designated by a customer and the stock prince (the Nikkei stock average) of the company in the period from Jan. 29, 2012 to Feb. 26, 2012.

In the cross chart 33, an ordinate on the left side in the drawing indicates a broadcast time (hour, minute, and second) of the broadcasting information, an ordinate on the right side in the drawing indicates stock prices, and an abscissa indicates a period.

In the cross chart 33, a positive evaluation chart (G), a negative evaluation chart (B), and a neutral evaluation chart (N) are formed and compared with a stock price chart (S).

Thus, the broadcasting information evaluation device 14 transmits the data of the cross chart 33 to the customer-side terminal 17 by the server 18 through the wide-area communication network 16 to complete the operation. The customer receives the cross chart 33 to make it possible to examine correlations between broadcasting information evaluated (the positive evaluation, the negative evaluation, and the neutral evaluation) and the stock prices. In addition, the relationships between the broadcasting information and the stock prices are examined to make it possible to predict a future influence of the broadcasting information on the stock prices.

In the broadcasting information evaluation device 14 according to the embodiment further includes the “most approximate economic indicator extraction means” 31. The “most approximate economic indicator extraction means” 31 uses Spearman rank-correlation coefficients to make it possible to also extract an economic indicator being most approximate to the positive evaluation chart, the negative evaluation chart, and the neutral evaluation chart from the plurality of economic indicators stored in the “economic indicator database” 24.

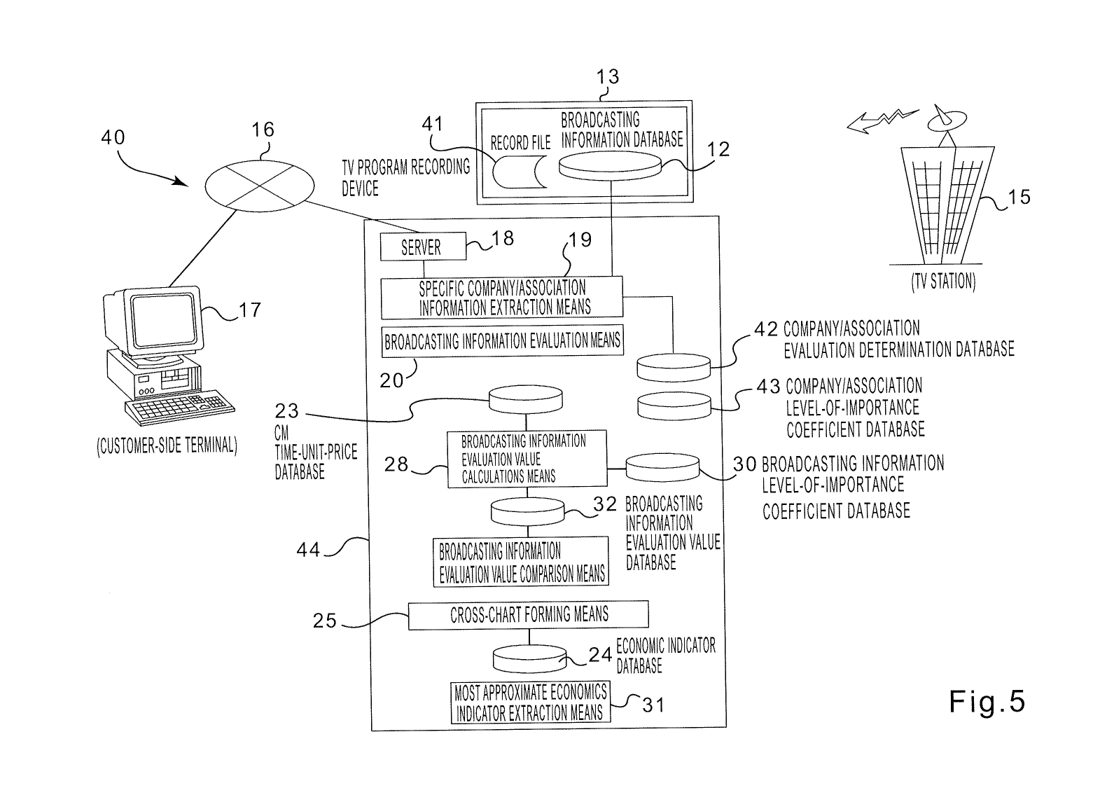

FIG. 5 shows a second embodiment of a video information analysis system according to the present invention. Only a configuration different from that of the above embodiment will be described below.

In a video information analysis system 40 according to the embodiment, the TV program video information storage device 13 has a “record data base” 41 that records all programs broadcasted on all the channels for a predetermined period and stores all the programs as broadcasting information. The “broadcasting information evaluation device” 44 further includes a “company/association evaluation determination database” 42 that stores determination data representing whether broadcasting information related to the specific company and the specific association extracted by the “specific company/association information extraction means” 12 has a positive evaluation obtained when a good influence is exerted on the specific company or the specific association, a negative evaluation obtained when a bad influence is exerted on the specific company or the specific association, or a neutral evaluation that is neither the positive evaluation nor the negative evaluation, and a “company/association level-of-importance database” 43 that stores a plurality of pieces of coefficient information representing levels of importance of broadcasting information in a broadcasted program related to the specific company or the specific association are stored in units of companies and associations.

The “specific company information extraction means” 19 is designed to search for and extract broadcasting information of a specific company or a specific association and texted broadcasting information requested from a customer by the customer-side terminal 17 from the record database 41 and the broadcasting information database 12 and to make it possible to search for and extract a company/association determination evaluation, a company/association level-of-importance coefficient, and a broadcasting information evaluation value from the “company/association evaluation determination database” 42, the “company/association level-of-importance coefficient database” 43, and the “broadcasting information evaluation value database” 32.

Thus, the TV broadcasting information analysis system 40 according to the embodiment, depending on a request from the customer, searches for and extracts all pieces of record information in a predetermined period related to a specific company or a specific association and broadcasting information serving as text data corresponding to the record information and an evaluation determination (positive evaluation, negative evaluation, or neutral evaluation) corresponding to the pieces of broadcasting information, a level-of-importance coefficient (coefficient of a level of importance of the company or the association in the broadcasting article determined depending on whether the specific company or the specific association in the broadcasting article is handled as a main issue, handled as a sub-issue, or handled as an issue except for the main issue and the sub-issue), and broadcasting information evaluation values calculated with reference to a CM price to make it possible to transmit the pieces of information, determination, the coefficient, and the evaluation value to the customer-side terminal 17 through the server 18.

As a result, the customer can instantaneously confirm all the pieces of record information in a predetermined period related to a specific company or a specific association of a requested specific company or association, broadcasting information serving as text data corresponding to the record information, and broadcasting information evaluation values calculated with reference to evaluation determinations, level-of-importance coefficients, and CM prices corresponding to the pieces of broadcasting information.

The embodiment describes an example in which, on the basis of a concrete request from a customer, a broadcasting information evaluation value related to a specific individual company or association is calculated to form a relationship with economic indicators as a cross chart. However, the present invention is not limited to the embodiment, and various themes, for example, relationships between various events such as “3.11”, “European finance crisis”, and “Flood in Thailand” occurring in the world and economic indicators can also be analyzed by a cross chart.

The configuration in which TV broadcasting information is analyzed depending on a request related to a concrete, specific, individual company or association from a customer to economically evaluate the specific company or association so as to make it possible to transmit a chart that can economically evaluate the specific company or association to the customer-side terminal 17 through the wide-area communication network 16 is exemplified. However, the present invention is not limited to the embodiment, for example, in a website established on a wide-area communication network, as an article, company/association evaluation determination results, company/association level-of-importance coefficients, broadcasting information level-of-importance coefficients, broadcasting information evaluation values, and company/association ranking based on the broadcasting information evaluation values are put in units of days, fiscal months, or fiscal years and disclosed, or a cross chart formed by a cross-chart forming means can also be put and disclosed without being limited to the embodiment.

Furthermore, in the “broadcasting information evaluation value database” 32, broadcasting information evaluation values calculated with respect to main domestic companies, for example, 4000 companies are always stored. For this reason, with respect to the top 200 to 300 companies in the 4000 companies, depending on a request from a customer, ranking information related to a ranking result of a specific company or association in the top 200 to 300 companies can also be provided as needed.

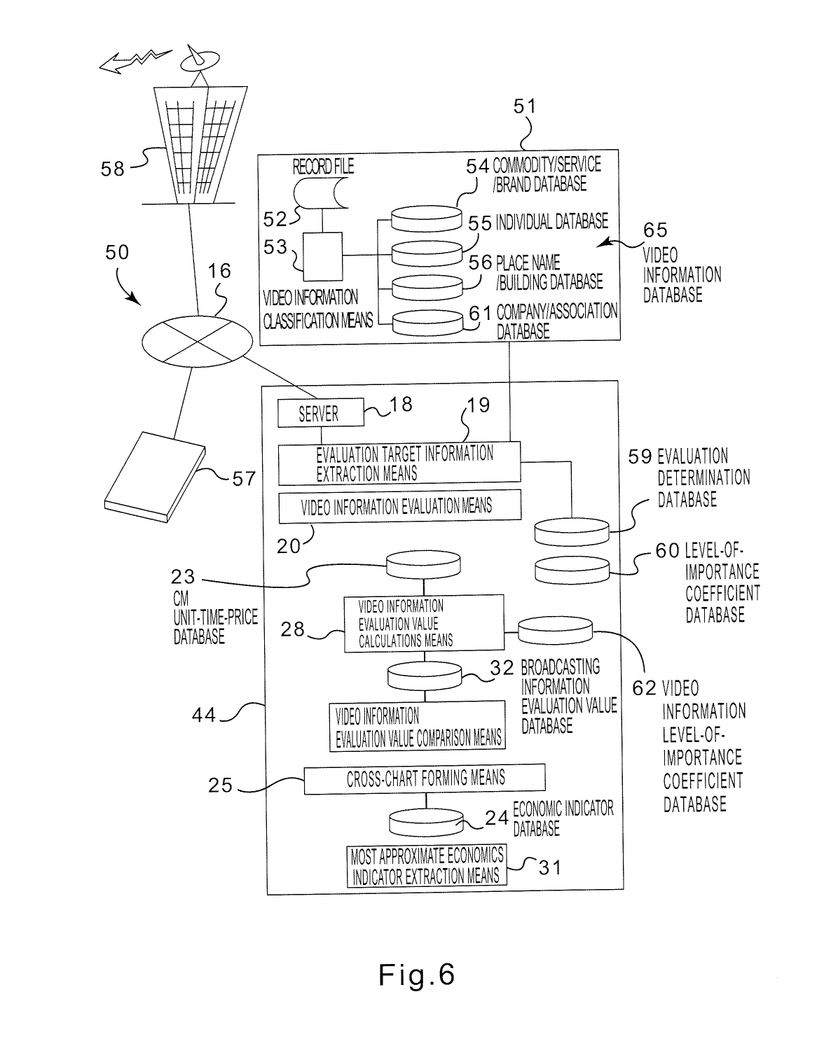

FIG. 6 shows another embodiment of the video information analysis system according to the present invention.

In the embodiment, the video information analysis system according to the present invention is applied to a case in which not only broadcasting information provided through televisions, but also video information including a moving image distributed through the Internet, and information such as news of companies that provide search engines are targeted, and, in addition to companies and associations, commodities, services, brands, individuals, place names, buildings, and the like are to be evaluated. Only points different from those in the second embodiment shown in FIG. 5 will be described below.

In a video image information analysis system 50 according to the embodiment, a video information storage device 51 is connected to a moving image information distributor and an internet search engine provider 50 through the Internet 16 in an electric signal manner. A video information evaluation device 72 is similarly connected to the video image information distributor or the internet search engine provider 50 and a mobile terminal (mobile phone, smart phone, or other various Pads) 57 owned by a customer and having a browser through the Internet 16 in a radio-wave manner (wirelessly).

In the embodiment, a video information analyzer who is requested from a customer having the mobile terminal 57 to evaluate a target holds the video information storage device 51 and a video information evaluation device 64.

The video information storage device 51 according to the embodiment is configured to make it possible to all pieces of video information such as a moving image and a still image distributed from the moving image information distributor or the internet search engine provider 58 through the internet 16 are recorded for a predetermined period, for example, one week or 24 weeks and to video data including sound in a record file 52.

As the image data stored in the record file 52, a text document manually summarized by a keyword with respect to a news video, a variety video, a drama video, a sports video, and the like, regardless of the types of videos, all videos, an in-video section, a commercial message (CM), in units of themes, a title of a video, an airdate of a program, broadcast time on the second time scale, a broadcast time length, video contents, sound, a telop, and a performer in all the videos, and a company name, an association name, a commodity name, a service name, a brand name, a personal name, a place name, and a building name that appear on the videos is stored in a video information database 65 built in the video video information storage device 51.

In the embodiment, the video information storage device 51 has a plurality of databases including a commodity/service/band database 54, an individual database 55, a place-name/building database 56, and a company/association database 61 in which pieces of video information are stored depending on the types of the pieces of video information, and includes a video information classification means 53 that classifies and stores the pieces of video information in the various databases. Thus, in the embodiment, a customer uses a PDA 57 such as a smart phone or a personal computer to make it possible to acquire information related to an economic value evaluation, a social evaluation, or a political evaluation related to a specific commodity, a service, a brand, an individual, a place name, a building, and a specific company or association.

Functions of a system will be described below with reference to an example in which, for example, a customer acquires information of an economic value evaluation of a certain commodity by using a video information analysis system 50 according to the embodiment.

The customer makes a “specific commodity evaluation request” to the video information evaluation device 64 through the Internet 16 by using of PDA 57. The video information evaluation device 64 accepts the request through the server 18. The request from the customer is made in the form of, for example, “want to know an economic evaluation of a XX commodity in X month”.

On the basis of the request from the customer, the video information evaluation device 64 accesses the commodity/service/brand database 54 built in the video information storage device 13 by the evaluation target information extraction means 19 to search for and acquire all video information data related to a specific commodity according to the request from the customer.

The video information evaluation means 20 calculates an evaluation value of each piece of video information related to according to the evaluation request from the customer. Calculation of the video information evaluation value is performed on the basis of a “video information evaluation value” calculated by converting the video information into a CM prices in units of video articles. The video information evaluation value calculation means 28 calculates a CM price on the second time scale with reference to the CM price table 26 of the CM time-unit-price database 23 shown in FIG. 2 and multiplies the CM price by the number of seconds of the video article to calculate a base value of the video information evaluation value.

In the calculation of the video information evaluation value, as described above, with respect to the video information related to the commodity acquired by the evaluation target information extraction means 19, a determination of a “positive evaluation”, a “negative evaluation”, and a “neutral evaluation” is manually made by the above method to set a coefficient (determination coefficient) in calculation of the video information evaluation value. In the embodiment, as the “positive evaluation”, the negative evaluation, and the neutral evaluation, “+1”, “−1”, and “no coefficient” are set, respectively.

In addition to the “positive evaluation”, the “negative evaluation”, and the “neutral evaluation”, a “level of importance of the commodity in the video article” is considered. More specifically, a level of importance of the commodity in the video article is determined depending on whether the commodity in the video article is handled as a main issue, handled as a sub-issue, or handled as an issue except for the main issue and the sub-issue to set a coefficient (level-of-importance coefficient). In the embodiment, as described above, the coefficient is set to “1” in case of the “main issue”, the coefficient is set to “0.5” in case of the “sub-issue”, and the coefficient is set to “0.1” in case of the “issue except for the main issue and the sub-issue”.

Thus, in the embodiment, the “video information value calculation means” 28, with reference to a time-unit price of the “commercial message time-unit price database” 23, multiplies the time-unit price by a broadcast time of the video information, adds the coefficients of the positive evaluation, the negative evaluation, and the neutral evaluation to calculate a base value of the video information evaluation value. Furthermore, the base value is multiplied by the level-of-importance coefficient to calculate a final broadcasting information evaluation value related to commodity to be determined.

As a result, in the embodiment, all pieces of record information in a predetermined period related to a commodity to be evaluated, text data information corresponding to the pieces of record information, an evaluation determination (positive evaluation, negative evaluation, or neutral evaluation) corresponding to the pieces of video information, a level-of-importance coefficient (coefficient of a level of importance of the commodity in the video article determined depending on whether the commodity in the broadcasting article is handled the main issue, handled as the sub-issue, or handled as the issue except for the main issue and the sub-issue), and a video information evaluation value calculated with reference to a CM price are searched for and extracted and can be transmitted to the customer-side terminal 17 through the server 18.

Thus, the customer can instantaneously confirm all the pieces of video information in a predetermined period related to a requested specific commodity, text data information corresponding to the record information, and video information evaluation values calculated with reference to an evaluation determination, a level-of-importance coefficient, and a CM price corresponding to the pieces of video information.

In recent years, companies may collaborate with each other to sell a plurality of commodities and brands in the same business background. For example, when a popular movie is newly released, clothes and a watch worn by a main character and an automobile or the like used by the main character may be mutually advertized by an apparel manufacturer, a watch manufacturer, and an automobile manufacturer in the wake of the movie. In such a case, the main character, the clothes, the watch, and the automobile that appear on the movie, manufacturers thereof, and brands, a movie company, a brand of the movie, and the like are synergically affected with each other to increase the commodity price. A restaurant, a hotel, a visited place, a building, and the like used by the main character of the movie in the movie may become famous in accordance with a hit of the movie.

In this case, the customer, by using the video information analysis system 50 according to the embodiment, request evaluations of all the above objects, i.e., individual commodities of a plurality of types, manufacturers/distributors of the commodities, brands themselves of the commodities, a movie, a film production company, a restaurant, a hotel, a building, and the place name to make it possible to confirm social evaluations or economical evaluations. In such a case, since the video information analysis system 50 according to the embodiment has the databases 54, 55, 56, and 61 related to a plurality of objects to be evaluated, the video information analysis system 50 can rapidly search for and extract information and can cyclopaedically evaluate the objects in response to the situation of collaboration for the above plurality of commodities.

Furthermore, with respect to evaluation of individuals including so-called famous persons such as politicians, economists, film actors, singers, and famous intellectuals who appear in the media, by using the system, video information evaluation values calculated with reference to all pieces of record information in a predetermined period, text data information corresponding to the pieces of record information, evaluation determinations (positive evaluation, negative evaluation, or neutral evaluation) corresponding to the pieces of video information, a level-of-importance coefficient (coefficient of a level of importance of the commodity in the video article determined depending on whether the commodity in the broadcasting article is handled as a main issue, handled as a sub-issue, or handled as an issue except for the main issue and the sub-issue), and the CM price are searched for, extracted, and transmitted to the PDA 57 through the server 18.

Thus, the customer can instantaneously confirm the video information evaluation values calculated with reference to all the pieces of video information in the predetermined period related to a specific individual who requests evaluation, the text data information corresponding to the record information, the evaluation determination corresponding to the pieces of video information, the level-of-importance coefficient, and the video information evaluation values calculated with reference to the CM price.

In the embodiment shown in FIG. 6, although the embodiment explains the example in which a video information analyzer whom a customer who owns the mobile terminal 57 requests to evaluate a target owns the video information storage device 51 and the video information evaluation device 64, not only the configuration of the embodiment, but also the following configuration may also be employed. That is, the video information analyzer uses cloud computing without holding the video information storage device 51, the video information storage device 51 is arranged in a cloud computer, and the video information evaluation device 64 accesses the video information database 65 on demand to make it possible to perform an evaluating operation for video information to be evaluated.

### INDUSTRIAL APPLICABILITY

Since the present invention can be popularly applied to a video information analysis system, the present invention has industrial applicability.

1. A video information analysis system that analyzes video information to evaluate a predetermined target comprising:
a video information storage device having a record file in which all programs broadcasted in all television channels or all videos distributed through the Internet are recorded or stored as video information for a predetermined period of time;
a video information database in which all the pieces of video information stored in the record file and text data of summaries of all the pieces of video information are stored; and
a video information evaluation device that extracts related video information data to be evaluated from the video information data stored in the video information database in units of articles to evaluate the related video information data,
wherein
the video information evaluation device has evaluation target information extraction means that searches for and extracts video information related to an evaluation target based on the text data stored in the video information database for a predetermined period of time, and video information evaluation means that calculates the evaluation value of the video information on the basis of a determination of whether the video information extracted by the evaluation target information extraction means has a positive evaluation obtained when a good influence is exerted on the evaluation target, a negative evaluation obtained when a bad influence is exerted on the evaluation target, or a neutral evaluation that is neither a positive evaluation nor a negative evaluation and stores the evaluation value in a video information evaluation value database.

2. The video information analysis system according to claim 1, wherein the video information is television broadcasting information, related to a broadcast station name, an in-program section, a commercial message (CM), in units of themes, a title of a program, an airdate of a program, broadcast time on the second time scale, cueing information on the second time scale, a broadcast time length on the second time scale, video contents, sound, a telop, a performer, and a company name, an association name, a commodity name, a brand name, a service name, a specific personal name, a specific place name, and a specific building name that appear on a program.

3. The video information analysis system according to claim 1, wherein the video information is video information including a moving image distributed through the Internet, and is related to an in-moving-image section, a commercial message (CM), in units of themes, a title of a video, a release date of a moving image, a publication site, a monitor, a sponsor, a performer, a director, video time on the second time scale, a video time length on the second time scale, video contents, sound, a telop, a performer, and a company name, an association name, a commodity name, a brand name, a service name, a specific personal name, a specific place name, and a specific building name that appear on a video.

4. The video information analysis system according to claim 1, wherein the video information evaluation means has a video information evaluation value calculation means, a commercial message time-unit-price database in which a table of station-classified time-unit-price information of a commercial message in each broadcast station is stored, and a video information evaluation value database, and
wherein the video information value calculation means is configured to, with reference to a time-unit-price of the commercial message time-unit-price database, multiply the time-unit-price by broadcast time of the corresponding video information and add each of coefficients of the positive evaluation, the negative evaluation, and the neutral evaluation to calculate a video information evaluation value related to an evaluation target, and store the video information evaluation value in the video information evaluation value database.

5. The video information analysis system according to claim 4, wherein the video information evaluation value calculation means calculates the video information evaluation value in consideration of a level of importance of an evaluation target in an article related to an evaluation target extracted by the evaluation target information extraction means.

6. The video information analysis system according to claim 5, wherein a level of importance of the evaluation target in the article is determined depending on whether the evaluation target in the article is handled as a main issue, a sub-issue, or an issue except for the main issue and the sub-issue, and the level of importance is converted into a coefficient and used in calculation of a video information evaluation value.

7. The video information analysis system according to claim 4, wherein the video information evaluation values are calculated with respect to a positive evaluation, a negative evaluation, and a neutral evaluation, respectively.

8. The video information analysis system according to claim 4, further comprising:
a video information evaluation value database in which video information evaluation values of a plurality of evaluation targets are stored in units of the evaluation targets, and video information evaluation value comparison means that totals the video information evaluation values stored in the video information evaluation value database in units of predetermined periods, compares the stored evaluation targets with each other, and performs ranking about the plurality of evaluation targets in units of predetermined periods.

9. The video information analysis system according to claim 1, wherein the video information evaluation device includes an economic indicator database having an economic indicator table in which information related to an economic indicator for a predetermined period is described, and “cross-chart forming means that searches for and extracts evaluation values of specific evaluation targets from the video information evaluation value database, extracts evaluation values of the specific targets based on an economic indicator from the economic indicator database, plots the evaluation values on the same coordinate axis for a predetermined period to make it possible to form a cross chart.

10. The video information analysis system according to claim 9, wherein the economic indicator database stores economic indicators related to stock prices, the Nikkei stock average, the Dow Jones Industrial Average, an average stock price of each country, the Shanghai foreign exchange market, currency exchange market prices of each country, petroleum prices, and gold market prices.

11. The video information analysis system according to claim 9, further comprising:
most approximate economic indicator extraction means that is configured to extract an economic indicator being most approximate to a chart of positive evaluation, a chart of negative evaluation, and a chart of neutral evaluation from a plurality of economic indicators stored in the economic indicator database by using Spearman rank-correlation coefficients or a mathematical technique of regression analysis.

12. The video information analysis system according to, wherein the video information storage device has a record file in which all programs broadcasted on all television channels or all videos including a moving image distributed through the Internet are recorded or stored as video information for a predetermined period and a video information database in which all the pieces of video information stored in the record file and text data of a summary of all the pieces of video information are stored,
wherein the video information evaluation device further includes: a target evaluation determination database in which determination data obtained depending on whether broadcasting information related to the evaluation target extracted by the evaluation target information extraction means has a positive evaluation obtained when a good influence is exerted on the evaluation target, a negative evaluation obtained when a bad evaluation is exerted on the evaluation target, and a neutral evaluation that is neither the positive evaluation nor the negative evaluation are stored in units of evaluation targets; and a level-of-importance coefficient database in which pieces of coefficient information representing levels of importance of pieces of video information related to the evaluation targets are stored in units of targets, and
wherein the evaluation target information extraction means searches for and extracts video information of a specific evaluation target requested from a customer through a customer-side terminal and texted information from the video information database and searches for and extracts target determination evaluation, a target level-of-importance coefficient, and a video information evaluation value from the evaluation determination database, a level-of-importance coefficient database, and the video information evaluation value database to provide the target determination evaluation, the target level-of-importance coefficient, and the video information evaluation value depending on a request from the customer.

13. The video information analysis system according to claim 1, wherein the evaluation target is any one of a specific company, a specific association, a specific commodity, a specific brand, a specific service, a specific individual, a specific place name, a specific building, a specific animal name, and a specific title of work.
